(19) United States
(12) Patent Application Publication
(10) Pub. No.: US 2013/0000271 A1
(43) Pub. Date: Jan. 3, 2013

(54) ENGINE SHIELD

(76) Inventor: Farr Sonei, Woodland Hills, CA (US)

(21) Appl. No.: 13/534,874

(22) Filed: Jun. 27, 2012

Related U.S. Application Data
(60) Provisional application No. 61/502,608, filed on Jun. 29, 2011.

(51) Int. Cl. F02G 3/00

(52) U.S. Cl. 60/39.092

(57) ABSTRACT

One example embodiment includes an engine shield for protecting a jet engine intake. The engine shield includes a base, a first support and a second support. The first and second supports include a first end and a second end opposite the first end and are attached to the base at a first end. The engine shield also includes an apex attached the second end of the first support and the second end of the second support. The base, first support, second support and apex define an inner volume with an inner surface and an outer volume with an outer surface. The engine shield further includes a ring. The ring is attached to the first support between the base and the apex and the second support between the base and the apex. The engine shield additionally includes a mesh, where the mesh covers the outer surface.

### CROSS-REFERENCE TO RELATED APPLICATIONS

This application claims the benefit of and priority to U.S. Provisional Patent Application Ser. No. 61/502,608 filed on Jun. 29, 2011, which application is incorporated herein by reference in its entirety.

### BACKGROUND OF THE INVENTION

Jet engines require a high amount of oxygen in order to operate. In general, the required oxygen is found in compressed air. I.e., the engine includes an air intake. The air is then compressed to the required pressure and then mixed with fuel, allowing the fuel to burn.

However, the intake can become fouled or otherwise clogged, which prevents the intake of air. In particular, birds and other debris can be drawn into the air intake. This can, in turn, prevent enough air from entering the engine to support the combustion process within the engine. To prevent this from occurring, a shield is generally placed over the air intake which prevents excessive debris buildup.

Currently, there are a number of problems with the shields used. For example, the shields are generally either a permanent attachment to the engine or difficult to change. This means that when/if damage occurs to the shield extensive work is required to change the shield. Normally this work requires that the plane not be in use for a period of time.

Removing or replacing the shield is also made more difficult by the high weight of the engine shield. The shield may be too heavy to be supported by an individual. This means that any change requires special machinery designed to support the engine shield during repairs or replacement of the engine shield.

Accordingly, there is a need in the art for an engine shield which is capable of being easily changed. Additionally, there is a need in the art for an engine shield which is low weight compared to existing engine shields. Further, there is a need in the art for the engine shield to be of sufficient strength to prevent debris from entering the engine.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes an engine shield for protecting a jet engine intake. The engine shield includes a base, a first support and a second support. The first and second supports include a first end and a second end opposite the first end and are attached to the base at a first end. The engine shield also includes an apex attached the second end of the first support and the second end of the second support. The base, first support, second support and apex define an inner volume with an inner surface and an outer volume with an outer surface. The engine shield further includes a ring. The ring is attached to the first support between the base and the apex and the second support between the base and the apex. The engine shield additionally includes a mesh, where the mesh covers the outer surface.

Another example embodiment includes an engine shield for protecting a jet engine intake. The engine shield includes a base approximately circular in shape, a first support and a second support. The first and second supports include a first end and a second end opposite the first end and are attached to the base at the first end. The engine shield also includes an apex approximately pyramidal in shape and attached the second end of the first support and the second end of the second support. The base, first support, second support and apex define an inner volume with an inner surface and an outer volume with an outer surface. The engine shield further includes a ring. The ring is attached to the first support between the base and the apex and the second support between the base and the apex. The engine shield additionally includes a mesh, where the mesh covers the outer surface. The engine shield moreover includes a dampening mechanism on the base configured to reduce vibration of the engine shield relative to the jet engine. The engine shield also includes an attachment configured to secure the base to the jet engine.

Another example embodiment includes system for protecting a jet engine intake. The system includes a jet engine configured to intake air for an internal combustion reaction. The system also includes an engine shield for protecting a jet engine intake. The engine shield includes a base approximately circular in shape, a first support and a second support. The first and second supports include a first end and a second end opposite the first end and are attached to the base at the first end. The engine shield also includes an apex approximately pyramidal in shape and attached the second end of the first support and the second end of the second support. The base, first support, second support and apex define an inner volume with an inner surface and an outer volume with an outer surface. The engine shield further includes a ring. The ring is attached to the first support between the base and the apex and the second support between the base and the apex. The engine shield additionally includes a mesh, where the mesh covers the outer surface. The engine shield moreover includes a dampening mechanism on the base configured to reduce vibration of the engine shield relative to the jet engine. The engine shield also includes an attachment configured to secure the base to the jet engine.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1A illustrates a top view of an engine shield frame;

FIG. 1B illustrates a side view of the engine shield frame;

FIG. 2A illustrates a top view of an engine shield;

FIG. 2B illustrates a side view of the engine shield; and

FIG. 3 illustrates an example of an engine shield on a jet engine.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

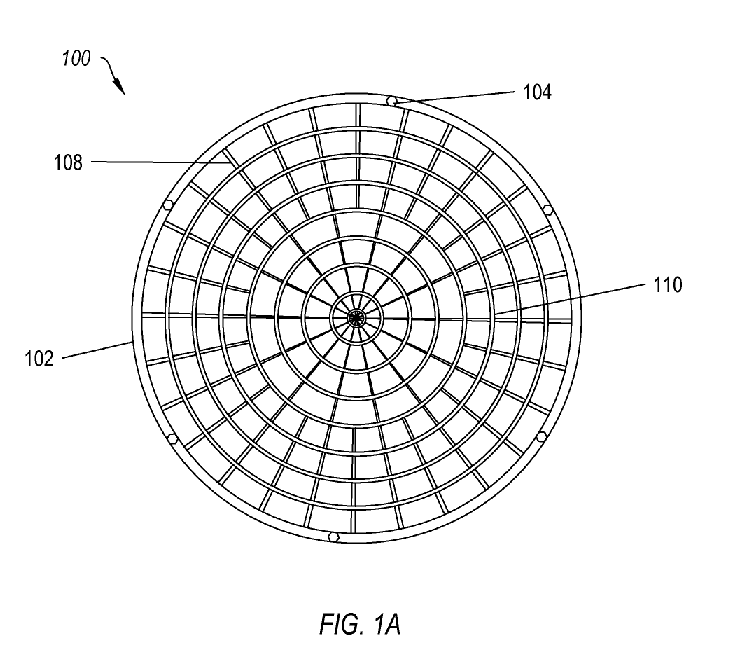

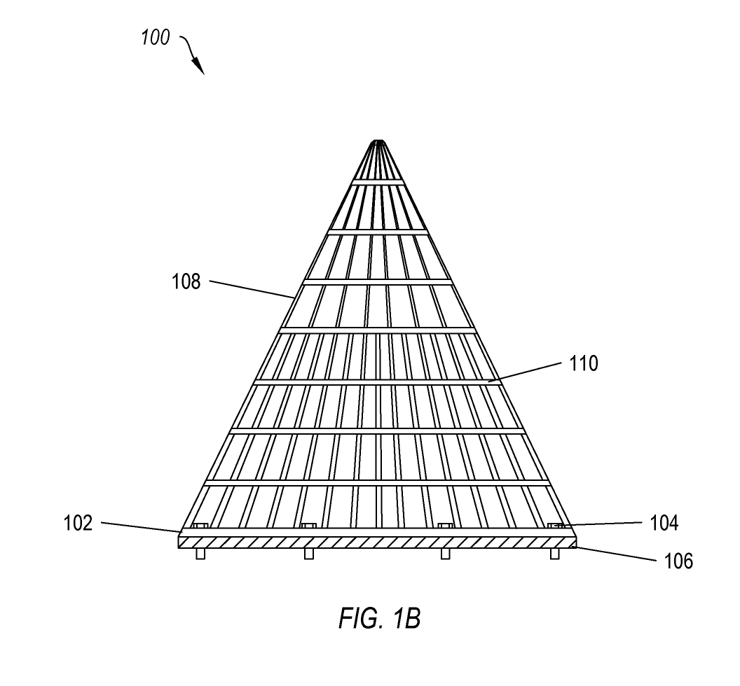

FIGS. 1A and 1B illustrate an example of an engine shield frame 100. FIG. 1A illustrates a top view of the engine shield frame 100; and FIG. 1B illustrates a side view of the engine shield frame 100. In at least one implementation, the engine shield frame 100 can provide a base structure for an engine shield. That is, the engine shield frame can allow an engine shield to be used to protect the intake of jet engines. The engine shield frame 100 can be made of hard plastics, metal, aluminum or other metal alloys.

FIGS. 1A and 1B show that the engine shield frame 100 can include a base 102. In at least one implementation, the base 102 can allow the engine shield frame 100 to fit against an engine intake. In particular, the base 102 can be of a desired shape and size to substantially match the intake of the jet engine over which the engine shield frame 100 will be placed. That is, the base 102 can allow the engine shield frame 100 to be fit snugly against the engine intake of a jet engine. For example, the base 102 can be circular, elliptical or any other desired shape. E.g., if the base 102 is circular it can have a diameter of between 3 and 5 feet. In particular, the diameter of the base 102 can be approximately 4 feet. As used in the specification and the claims, the term approximately shall mean that the value is within 10% of the stated value, unless otherwise specified.

FIGS. 1A and 1B also show that the base 102 can include one or more attachments 104. In at least one implementation, the attachments 104 are configured to allow the engine shield frame 100 to be attached to the engine. For example, the attachments 104 can include one or more bolts, bolt holes or other attachment mechanisms for allowing the engine shield frame 100 to be attached directly to the engine. Additionally or alternatively, the base 102 and/or the engine intake can include metal clips that will allow the base 102 to be secured to the intake of the engine.

Additionally or alternatively, the base 102 can include a dampening mechanism 106. In at least one implementation, the dampening mechanism 106 can reduce or eliminate vibration of the engine shield frame 100 relative to the engine. For example, the dampening mechanism 106 can include a rubber seal. Reduction of vibration can reduce noise and/or prevent wear on both the engine shield frame 100 and the engine. Additionally or alternatively, the dampening mechanism 106 can allow for a better fit between the base 102 and the jet engine. In particular, the dampening mechanism 106 can include some “give” allowing it to fit tightly against both the base 102 and the engine.

FIGS. 1A and 1B also show that the engine shield frame 100 can include one or more supports 108. In at least one implementation, the one or more supports 108 can be attached to the base 102. The one or more supports 108 can form a frame, or a portion of a frame, that will be used to support material which protects the engine intake, as described below. For example, the one or more supports 108 can extend from the base 102 in approximately a conical shape. For example, the supports 108 can be spaced between 4 and 6 inches along the base 102. In particular, the supports 108 can be spaced approximately 5 inches apart along the base 102. The one or more supports 108 can include tubing, which provides high strength will lower weight.

The supports 108 can be angled relative to the base 102. That is, the base 102 can form a plane with the supports 108 angled relative to the plane with supports 108 within the plane being angled at 0 degrees and supports 108 perpendicular to the plane being angled at 90 degrees. For example, the supports 108 can be angled between 51 degrees and 77 degrees relative to the base 102. In particular, the supports 108 can be angled approximately 64 degrees relative to the base 102.

FIGS. 1A and 1B further show that the engine shield frame 100 can include one or more rings 110. In at least one implementation, the one or more rings 110 can add strength the engine shield frame 100. In particular, the one or more rings 110 can be attached to the one or more supports 108. Together the one or more supports 108 and the one or more rings 110 can form a rigid conical shape. For example, the rings 110 can be spaced between 5 and 7 inches vertically from one another and from the base 102. In particular, the rings 110 can be spaced approximately 6 inches vertically from one another and from the base 102. As used herein, the distance vertically refers to a measurement along a line perpendicular to the plane of the base 102. I.e., the vertical measurement refers to the difference in distance from the plane of the base 102.

FIGS. 1A and 1B additionally show that the supports 108 need not all extend the same length. I.e., some supports 108 will extend to or past the topmost ring 110. In contrast, other supports 108 will extend only from the base 102 to an intermediary ring 110. This can occur because of the angle of the supports 108 relative to the base 102 means that each ring 110 will have a smaller diameter than any ring 110 closer to the base 102. As the diameter narrows, the supports 108 become closer to one another. Therefore, some of the supports 108 need not connect to the final ring 110.

One of skill in the art will appreciate that the conical shape can prevent perpendicular strikes against the engine shield frame 100. In particular, debris which strikes the engine shield frame 100 will approach from a direction which is approximately parallel to the axis of the cone. Such debris will be redirected by the conical shape away from the engine intake.

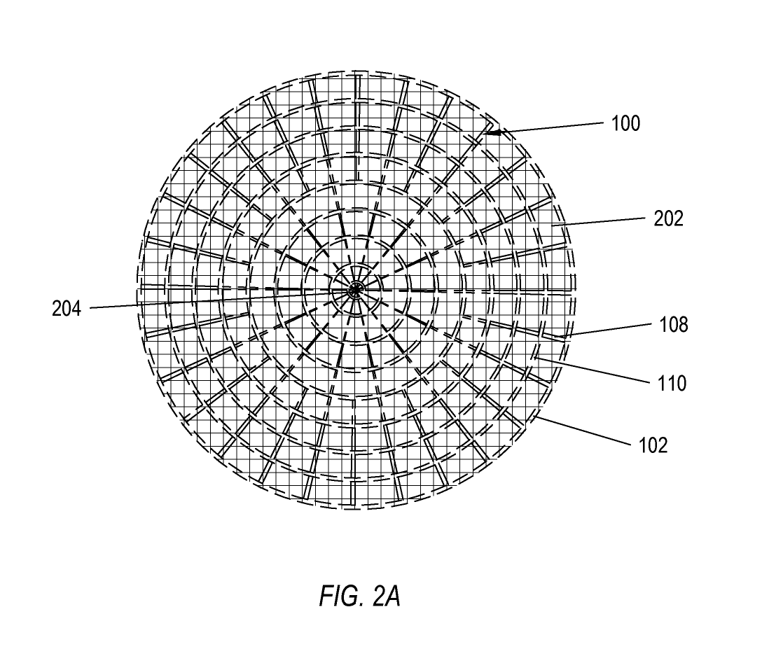

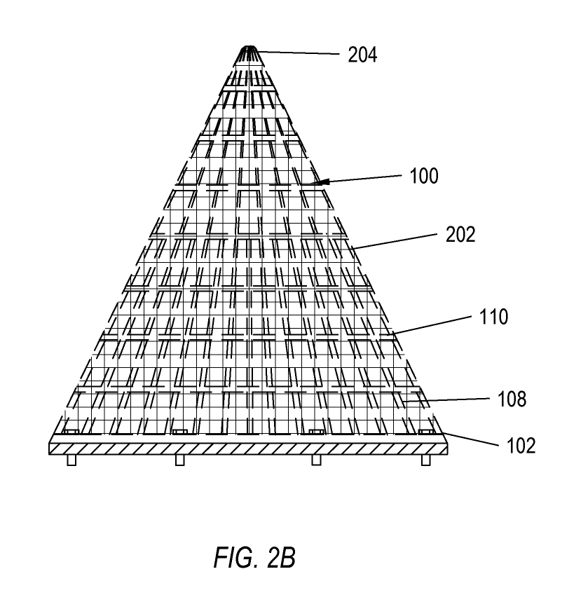

FIGS. 2A and 2B illustrate an example of an engine shield 200. FIG. 2A illustrates a top view of the engine shield 200; and FIG. 2B illustrates a side view of the engine shield 200. In at least one implementation, the engine shield 200 can protect the intake of jet engines. In particular, the engine shield 200 will protect the engine from the impact of flying birds and other objects. The engine shield 200 can be made of any suitable material. For example, the engine shield 200 can be made of hard plastics, metal, aluminum or other metal alloys.

FIGS. 2A and 2B show that the engine shield 200 can be built on an engine shield frame 100. In at least one implementation, the engine shield frame 100 makes up the bulk of the strength and mass of the engine shield 200 while other components of the engine shield 200 prevent debris from entering the engine. That is, the engine shield frame 100 holds the other components in place while the other components protect the jet engine. One of skill in the art will appreciate, however, that debris that strikes the engine shield frame 100 will likewise be diverted from the jet engine.

FIGS. 2A and 2B additionally show that the engine shield 200 can include a mesh 202. In at least one implementation, the mesh 202 can prevent debris from entering the engine intake. In particular, the mesh 202 can allow substantial air flow while preventing debris larger than the opening in the mesh to enter the engine shield and, therefore, the engine intake. I.e., the mesh 202 can include a semi-permeable barrier made of connected strands of metal, fiber, or other flexible/ductile material. The mesh 202 is similar to web or net in that it has many attached or woven strands.

FIGS. 2A and 2B also show that the engine shield 200 can include an apex 204. In at least one implementation, the apex 204 can include a solid piece of material. In particular, the apex 204 can include a pointed, pyramid shaped object. A pyramid shape can add strength to the engine shield 200 in the case of a direct impact with birds or other debris which hits the apex 204. Additionally or alternatively, the apex 204 can be rounded to deflect any debris from the jet engine.

Additionally or alternatively, the apex 204 can be attached to the one or more supports 108 and keep the one or more supports 108 aligned with one another. Because the apex 204 aligns the supports 108 there need not be a ring 110 near the apex. For example, the vertical distance between the apex 204 and the nearest ring 110 can be between 3 inches and 5 inches. In particular, the vertical distance between the apex 204 and the nearest ring 110 can be approximately 4 inches. The vertical distance between the apex 204 and the base 102 will depend on the diameter of the base 102 and the angle of the supports 108 relative to the base 102. For example, with vertical distance between the apex 204 and the base 102 can be between 3 feet and 5 feet. In particular, the vertical distance between the apex 204 and the base 102 can be approximately 4 feet. The apex 204 can be quite small because of the narrowing diameter of the engine shield frame 100. For example, the apex 204 can be between 0.75 inches and 1.25 inches high and between 1.5 inches and 2.5 inches wide. In particular, the apex 204 can be approximately 1 inch high and approximately 2 inches wide.

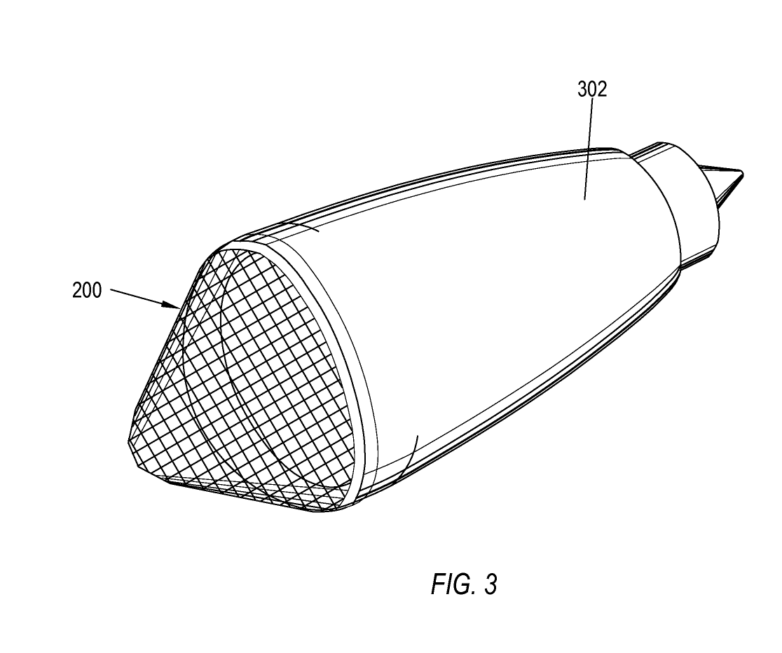

FIG. 3 illustrates an example of an engine shield 200 on a jet engine 302. In at least one implementation, the jet engine 302 requires air intake for its function. In particular, the higher within the atmosphere that the jet engine 302 is operating, the thinner the atmosphere becomes and the more that a blockage or other disruption in airflow could cause the jet engine 302 to fail.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A engine shield for protecting a jet engine intake, the engine shield comprising:
a base;
a first support:
including:
a first end; and
a second end opposite the first end; and
attached to the base at the first end;
a second support:
including:
a first end; and
a second end opposite the first end; and
attached to the base at the first end;
an apex attached to:
the second end of the first support; and
the second end of the second support;
wherein the base, first support, second support and apex define an inner volume with an inner surface and an outer volume with an outer surface;
a ring, wherein the ring is attached to:
the first support between the base and the apex; and
the second support between the base and the apex; and
a mesh, wherein the mesh covers the outer surface.

2. The engine shield of claim 1 further comprising an attachment configured to secure the base to the jet engine.

3. The engine shield of claim 1, wherein the attachment includes a bolt hole.

4. The engine shield of claim 3, wherein the attachment includes a bolt.

5. The engine shield of claim 1 further comprising a dampening mechanism on the base configured to reduce vibration of the engine shield relative to the jet engine.

6. The engine shield of claim 5, wherein the dampening mechanism includes a rubber seal.

7. The engine shield of claim 1, wherein the first support and the second support are at an angle of between 51 degrees and 77 degrees relative to a plane formed by the base.

8. The engine shield of claim 7, wherein the first support and the second support are at an angle of approximately 64 degrees relative to a plane formed by the base.

9. The engine shield of claim 1, wherein the distance between the first support and the second support along the base is between 4 inches and 6 inches.

10. The engine shield of claim 9, wherein the distance between the first support and the second support along the base is approximately 5 inches.

11. A engine shield for protecting a jet engine intake, the engine shield comprising:
a base approximately circular in shape;
a first support:
including:
a first end; and
as second end opposite the first end; and
attached to the base at the first end;
a second support:
including:
a first end; and
as second end opposite the first end; and
attached to the base at the first end;
an apex:
approximately pyramidal in shape; and
attached to the second end of the first support; and
attached to the second end of the second support;
wherein the base, first support, second support and apex define an inner volume with an inner surface and an outer volume with an outer surface;
a ring, wherein the ring is attached to:
the first support between the base and the apex; and
the second support between the base and the apex;
a mesh, wherein the mesh covers the outer surface;
a dampening mechanism on the base configured to reduce vibration of the engine shield relative to the jet engine; and
an attachment configured to secure the base to the jet engine.

12. The engine shield of claim 11, wherein the vertical distance between the base and the ring is between 5 inches and 7 inches.

13. The engine shield of claim 12, wherein the vertical distance between the base and the ring is approximately 6 inches.

14. The engine shield of claim 11, wherein the vertical distance between the ring and the apex is between 3 inches and 5 inches.

15. The engine shield of claim 14, wherein the vertical distance between the ring and the apex is approximately 4 inches.

16. A system for protecting a jet engine intake, the system comprising:
a jet engine configured to intake air for an internal combustion reaction; and
an engine shield including:
a base approximately circular in shape;
a first support:
including:
a first end; and
as second end opposite the first end; and
attached to the base at a first end;
a second support:
including:
a first end; and
as second end opposite the first end; and
attached to the base at a first end;
an apex:
approximately pyramidal in shape; and
attached to the second end of the first support; and
attached to the second end of the second support;
wherein the base, first support, second support and apex define an inner volume with an inner surface and an outer volume with an outer surface;
a ring, wherein the ring is attached to:
the first support between the base and the apex; and
the second support between the base and the apex;
a mesh, wherein the mesh covers the outer surface.
a dampening mechanism on the base configured to reduce vibration of the engine shield relative to the jet engine; and
an attachment configured to secure the base to the jet engine.

17. The system of claim 16, wherein the vertical distance between the base and the apex is between 3 feet and 5 feet.

18. The system of claim 17, wherein the vertical distance between the base and the apex is approximately 4 feet.

19. The system of claim 16, wherein the apex is between 0.75 inches and 1.25 inches high and between 1.5 inches and 2.5 inches wide.

20. The system of claim 19, wherein the apex is approximately 1 inch high and approximately 2 inches wide.
